(19) United States
(12) Patent Application Publication
(10) Pub. No.: US 2014/0280647 A1
(43) Pub. Date: Sep. 18, 2014

(54) Communication Apparatus and Related Methods

(71) Applicants: Richard H. Gehman, Royersford, PA (US); Kyle Eddins, Wesley Chapel, FL (US); Jeffrey C. DeSantis, West Chester, PA (US)

(72) Inventors: Richard H. Gehman, Royersford, PA (US); Kyle Eddins, Wesley Chapel, FL (US); Jeffrey C. DeSantis, West Chester, PA (US)

(21) Appl. No.: 14/205,562

(22) Filed: Mar. 12, 2014

Related U.S. Application Data
(60) Provisional application No. 61/776,935, filed on Mar. 12, 2013.

(51) Int. Cl. H04L 12/58

(52) U.S. Cl. CPC H04L 51/046
USPC 709/206

(57) ABSTRACT

A communication apparatus and related methods is disclosed. The communication apparatus includes a server and a first user device in communication with the server, wherein a message is communicated to the server, the message including at least one data string having at least one recognizable keyword. A keyword module is stored at least partially on the server, wherein the keyword module matches the at least one recognizable keyword with a related characteristic of the at least one recognizable keyword. A stamping module is in communication with the keyword module, wherein the stamping module embeds a stamp within the message, the stamp having at least a portion of the matched related characteristic of the data string. A second user device is in communication with the server, wherein the second user device visually displays the message having the at least one data string and the matched related characteristic within the stamp on a display interface of the second user device.

### CROSS REFERENCE TO RELATED APPLICATION

This application claims benefit of U.S. Provisional Application Se. No. 61/776,935 entitled, “Communication Apparatus and Related Methods” filed Mar. 12, 2013, the entire disclosure of which is incorporated herein by reference.

### FIELD OF THE DISCLOSURE

The present disclosure is generally related to communicating messages and more particularly is related to a communication apparatus and related methods.

### BACKGROUND OF THE DISCLOSURE

Many communication devices exist on the market today. Some of these communication devices utilize software applications or ‘apps’ to facilitate communication between computing devices, such as laptops or mobile phones. One of the most popular communication devices is Twitter, a popular online social networking service that allows users to send and receive text-based messages called ‘tweets’. Twitter users may construct a text-based message that is communicated through a plurality of servers and to another Twitter user, who can view the communicated message on a messaging interface. FIG. 1 is a schematic illustration of a messaging interface 10 of Twitter, in accordance with the prior art. The messaging interface 10 includes a plurality of messages 20. Each message includes an associated identification 30 and an address 40, which can correspond to the entity originating the message 20 or an entity resending the message 20. A textual statement 50, such as a word, words, or sentence about a topic or topics is included with the message 20. The message 20 may also include text characters prefixed with a hashtag (#), which acts to identify that message 20 as a particular topic or type.

While conventional messaging systems such as Twitter have their benefits, they suffer from many shortcomings. Messages 20 on Twitter are often varied in their purpose or topic. A user may receive a message 20 and not understand the meaning, topic, or purpose of the textual statement 50. Similarly, a recipient of the message 20 may understand the meaning of the textual statement 50, but he or she may want more information on the textual statement 50. In either case, a recipient of the message 20 may be forced to turn to sources outside of Twitter, such as the Internet or other reference, to fully appreciate the message 20 they received. For example, a non-sports enthusiast may receive a message 20 with a particular player's name within the textual statement 50 and not know who this player is, which team he or she plays for, or why the player is relevant to the message 20. To answer these unknowns, the non-sports enthusiast would need to utilize sources external to Twitter.

Thus, a heretofore unaddressed need exists in the industry to address the aforementioned deficiencies and inadequacies.

### SUMMARY OF THE DISCLOSURE

Embodiments of the present disclosure provide a communication apparatus and related methods. Briefly described, in architecture, one embodiment of the apparatus, among others, can be implemented as follows. The communication apparatus includes a server and a first user device in communication with the server, wherein a message is communicated to the server, the message including at least one data string having at least one recognizable keyword. A keyword module is stored at least partially on the server, wherein the keyword module matches the at least one recognizable keyword with a related characteristic of the at least one recognizable keyword. A stamping module is in communication with the keyword module, wherein the stamping module embeds a stamp within the message, the stamp having at least a portion of the matched related characteristic of the data string. A second user device is in communication with the server, wherein the second user device visually displays the message having the at least one data string and the matched related characteristic within the stamp on a display interface of the second user device.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic illustration of a messaging interface of Twitter, in accordance with the prior art.

FIG. 2 is a schematic illustration of a communication apparatus, in accordance with a first exemplary embodiment of the present disclosure.

FIG. 3 is a schematic illustration of a transmitting messaging interface of the communication apparatus of FIG. 2, in accordance with the first exemplary embodiment of the present disclosure.

FIG. 4 is a schematic illustration of a receiving messaging interface of the communication apparatus of FIG. 2, in accordance with the first exemplary embodiment of the present disclosure.

FIG. 5 is a schematic illustration of a communication apparatus, in accordance with a second exemplary embodiment of the present disclosure.

FIG. 6 is a schematic illustration of a dynamic data page of the communication apparatus of FIG. 5, in accordance with the second exemplary embodiment of the present disclosure.

FIGS. 7-9 are schematic illustrations of messages transmitted by a communication apparatus, in accordance with a third exemplary embodiment of the present disclosure.

### DETAILED DESCRIPTION

FIG. 2 is a schematic illustration of a communication apparatus 110, in accordance with a first exemplary embodiment of the present disclosure. The communication apparatus 110, which may be referred to simply as ‘apparatus 110’ includes a server 120. A first user device 130 is in communication with the server 120, wherein a message 140 is communicated to the server 120, the message 140 including at least one data string 150 having at least one recognizable keyword 160. A keyword module 122 is stored at least partially on the server 120, wherein the keyword module 122 matches the at least one recognizable keyword 160 with a related characteristic 170 of the at least one recognizable keyword 160. A stamping module 124 is in communication with the keyword module 122, wherein the stamping module 124 embeds a stamp 180 within the message 140, the stamp 180 having at least a portion of the matched related characteristic 170 of the data string 150. A second user device 134 is in communication with the server 120, wherein the second user device 134 visually displays the message 140 having the at least one data string 150 and the matched related characteristic 170 within the stamp 180 on a display interface 136 of the second user device 134.

The apparatus 110 may be used for communicating messages between any number of users in any location. The apparatus 110 may utilize a variety of communication methods including wired communication, wireless communication, Internet-based communication, or any other communication system known in the art. The apparatus 110 may include many different computing components to enable full functionality, including any type of hardware component and various software components. In addition to the hardware and software components disclosed explicitly herein, the apparatus 110 may also include any other hardware or software component that is used within the industry to enable electronic communication. The server 120 is a computer or combination of computing devices and hosts various modules and programs. The first user device 130 may include any type of computing device, such as a mobile phone, tablet computer, laptop computer, or other computing device, which is in communication with the server 120. The first user device 130 has a memory and processor executing a software application for electronic messaging, such that the user of the first user device 130 can construct a message within the first user device 130 to transmit from the first user device 130 to the server 120 and to other users.

The message 140 includes at least one data string 150 having at least one recognizable keyword 160. The data string 150 may be characterized as a textual-based combination of data. For example, the data string 150 could include a combination of letters, a word, a partial sentence, a full sentence, or any other combination of text characters. The recognizable keyword 160 may be one or more of the letters or words contained within the data string 150. For example, a message 140 may include a data string 150 stating, “Great Panthers game!” and the recognizable keyword may include the term “Panthers.” The data string 150 may include any number of recognizable keywords 160.

The keyword module 122 is a software based application or program that is stored at least partially on the server 120. The keyword module 122 receives the message 140 with the data string 150 from the first user device 130 and parses down the data string 150 to identify the recognizable keyword 160 contained therein. The identity of the recognizable keyword 160 may be based on a number of factors, including relevance, topic, time, and/or location, among other factors. For example, the keyword module 122 may recognize the data string of “Great Panthers game!” to determine that the term “Panthers” has the highest relevancy to the topic of the data string 150.

The keyword module 122 then uses algorithms to match the identified recognizable keyword 160 of the data string 150 to an index database containing a large quantity of possible matches for characteristics related to the identified recognizable keyword 160. The index database, for example, may contain an ever-updating, dynamic, and/or extremely large number of possible matches to the identified recognizable keyword 160. For example, the recognizable keyword 160 of “Panthers” may be matched within the index database to determine that the term “Panthers” refers to the professional football team, The Carolina Panthers. The identified recognizable keyword 160 is then matched to a related characteristic 170 of the identified recognizable keyword 160. This related characteristic 170 may include any type of characteristic of the identified recognizable keyword 160. For example, for a recognizable keyword 160 of “Panthers” the related characteristic 170 may include a current score of a game that the Carolina Panthers are playing in. For other recognizable keywords 160, the related characteristic 170 may include other information or data about the particular keyword 160.

The stamping module 124 is in communication with the keyword module 122 and uses the information determined within the keyword module 122 to embed a stamp 180 within the message 140. The stamp 180 includes at least a portion of the matched related characteristic 170 of the data string 150, and may be fully comprised of only the matched related characteristic 170 or a portion thereof. For example, the stamp 180 may be a current score to the Panthers game. The stamp 180 may also include a number of other features, such as multiple matched related characteristic 170, graphical designs, colors, symbols, logos, and hyperlinks, among others. As is shown in FIG. 2, the stamp 180 includes a rectangular area containing multiple matched related characteristic 170, i.e., the score “GB 7-SF 0” and the designation “Q1” (identifying the quarter of the game corresponding to the score). The stamp 180 may be a static stamp that is unchanged over a period of time, or a dynamic stamp that is updated over a period of time. For example, as the Panthers game continues on to the second quarter (Q2), the stamp 180 may be updated to reflect a change in score. A user who views the stamp 180 at different times may see changed matched related characteristics 170.

Similar to the first user device 130, the second user device 134 may include any type of computing device. The second user device 134 is in communication with the server 120 and allows a user of the second user device 134 to access or retrieve the message 140 transmitted from the first user device 130. The second user device 134 visually displays the message 140 on a display interface 136, such as a GUI, on the second user device 134. The message 140 displayed on the display interface 136 includes the data string 150 and the matched related characteristic 170 within the stamp 180. In other words, the second user device 134 allows the user to see the original data string 150 constructed on the first user device 130 as well as the stamp 180 having the matched related characteristic 170. The data string 150 and the stamp 180 with matched related characteristic 170 may be displayed simultaneously within the message 140, such that the user can visually identify them without having to navigate elsewhere, select anything within the message 140, or otherwise manipulate the message 140.

The apparatus 110 offers particular benefits in allowing users of electronic messaging systems to communicate better, by being able to add additional context to a communicated message. In addition to receiving the message 140, the recipient of the message 140 may also receive data within the stamp 180 and matched related characteristics 170 which yields context to the message 140. As can be seen, this ability may allow a user who is unfamiliar with the topic of a data string 150 to utilize the matched related characteristics 170 within the stamp 180 to better understand the data string 150. Using the example of the Panthers, a recipient of the data string 150 who is not familiar with sports may not who or what the Panthers are, but may be able to glean the context of the data string 150 by using the matched related characteristics 170 within the stamp 180. Similarly, users who want more information about the data string 150 may utilize the matched related characteristics 170 within the stamp 180 to gain that information.

FIG. 3 is a schematic illustration of a transmitting messaging interface 190 of the communication apparatus 110 of FIG. 2, in accordance with the first exemplary embodiment of the present disclosure. The transmitting messaging interface 190 may be where a user constructs the message 140 by writing the data string 150 with the recognizable keyword 160. While FIG. 3 identifies the recognizable keywords 160 as “#jets” and “#panthers” with the hashtag, any number of other keywords could be recognized, including those without a hashtag. For example, the term “preseason” within the data string 150 of the message 140 may be a recognizable keyword 160 as well. The use of the hashtag within the data string 150 may be useful in determining a recognizable keyword 160, but the hashtag is not necessary for the apparatus 110 to function since the keyword module 122 (FIG. 2) is capable of determining the recognizable keyword 160 without a hashtag.

FIG. 4 is a schematic illustration of a receiving messaging interface 192 of the communication apparatus 110 of FIG. 2, in accordance with the first exemplary embodiment of the present disclosure. The receiving messaging interface 192 may be displayed on the display interface 136 of the second user device 134 (FIG. 2), wherein a user of the apparatus 110 is capable of viewing the message 140 sent from the first user device 130. As is shown, any number of messages 140 may be shown within the receiving messaging interface 192. The messages 140, or a portion thereof, include the data string 150 with the recognizable keyword 160, some of which may include hashtags, others which may not. For example, in the upper-most message 140, the data string 150 of “Watching this preseason game. #jets #panthers”, where the words “preseason”, “#jets”, and “#panthers” are the most prominent recognizable keywords 160. In the second message 140 from the top, the data string 150 is “Felix Hernandez is a stud!” where the terms “Felix Hernandez” are the recognizable keywords 160, and in the third message 140 from the top, the data string 150 is “Yu darvish is pitching tonight! :)” where the terms “Yu darvish” are the recognizable keywords 160.

Each of these messages 140 also includes the stamp 180 visibly showing the related characteristics 170 of the recognizable keywords 160 that were matched within the keyword module 122 (FIG. 2). As can be seen, for the first message 140, the stamp 180 is a graphical marking that is distinct from the data string 150, with the matched related characteristics 170 depicted within the graphical marking. Specifically, the matched related characteristics 170 for this message 140 are “CAR 3-NYJ 3 1^{st} Q 07:32” which corresponds to the score of the game between the Carolina Panthers and the New York Jets at a time of 7:32 within the first quarter of the game. In this example, the recognizable keywords of “#jets”, “#panthers”, and “preseason” alone or in combination with each other is easily matched to the game between the two teams at the time the message 140 was transmitted.

For the message 140 second from the top, the stamp 180 is also a graphical marking containing the matched related characteristics 170 of “TB 0-SEA 1 Bot 6 2 Outs.” The recognizable keyword 160 for the data string 150 of this message 140 is “Felix Hernandez” who is a pitcher for the Seattle Mariners professional baseball team. Thus, the matched related characteristics 170 to “Felix Hernandez” at the time the message 140 was transmitted is the score of the baseball game between the Tampa Bay Rays and the Seattle Mariners, which is at the bottom of the 6^{th} inning with 2 outs. For the message 140 third from the top, the stamp 180 is a graphical marking with the matched related characteristics 170 of “8/28 NYY @ TEX 8:05 pm.” The recognizable keyword 160 for the data string 150 of this message 140 was “Yu darvish” which is the name of a pitcher for the Texas Rangers professional baseball team. Thus, the matched related characteristics 170 to “Yu darvish” at the time the message 140 was transmitted is relevant data about a future game between the New York Yankees and the Texas Rangers, which is scheduled to be played on August 28^{th} (8/28) at 8:05 pm.

The stamp 180 may include a variety of different graphical markings, having various shapes, colors, formats, and sizes. The stamp 180 may also be positioned in a number of locations within the message 140, so long as the stamp 180 is independent of the original data string 150. In other words, the stamp 180 is distinct from the data string 150 and is not a portion of the data string 150 or some alteration thereof. A user is able to view the data string 150 and the stamp 180 containing the matched related characteristics 170 within the same message 140. The stamp 180 can also include just the matched related characteristics 170 without any graphical markings. It is noted that the matched related characteristics 170 and/or stamp 180 can be dynamic, in that, the matched related characteristics 170 can be updated over a period of time. For example, the stamp 180 with the matched related characteristics 170 in the examples above can each be updated to reflect a change in score or the progression of the time of the game, among other changes.

FIG. 5 is a schematic illustration of a communication apparatus 210, in accordance with a second exemplary embodiment of the present disclosure. The communication apparatus 210 which may be referred to simply as ‘apparatus 210’ may include any of the structures, features, or functions disclosed with respect to any embodiment of this disclosure. The apparatus 210 includes a plurality of servers 220 in communication with at least a first user device 230 and a plurality of second user devices 234. The first user device 230 is in communication with a first server 220, wherein a message is communicated to the first server 220. The message has at least one data string having at least one recognizable keyword. A keyword module is stored at least partially on one of the servers 220, wherein the keyword module matches the at least one recognizable keyword with a related characteristic of the at least one recognizable keyword 160. A stamping module is in communication with the keyword module, wherein the stamping module embeds a stamp within the message, the stamp having at least a portion of the matched related characteristic of the data string. The second user device 234 is in communication with the servers 220, and visually displays the message having the at least one data string and the matched related characteristic within the stamp on a display interface of the second user device 234.

The apparatus 210 of FIG. 5 functions substantially similar to the apparatus 110 of FIGS. 2-4, but also includes additional functionality. For example, at step 1, the message is sent from the first user device 230 to the server for keyword matching and stamping. At step 2, the message with the original data string and the stamp containing the matched related characteristic is sent to a second server, such as a networking communication server (e.g., Twitter's server). At step 3, the message is transmitted to the second user devices 234 so they can view the message with the data sting and stamp having the matched related characteristic, and the message with the data string and stamp having the matched related characteristic is sent back to the first user device 230. If the user of the second user device 234 desires, he or she can select a link within the stamp that requests additional information or data relevant to the matched related characteristic, for example, details about a game beyond just the score and time left to play (step 4). The request is sent to the server 220 which transmits those additional details to the second user device(s) 234 (step 5).

FIG. 6 is a schematic illustration of a dynamic data page 212 of the communication apparatus 210 of FIG. 5, in accordance with the second exemplary embodiment of the present disclosure. The dynamic data page 212 may be the interface that is presented to the user of the second user device 234 (FIG. 5) when he or she selects the link within the stamp that requests additional information or data relevant to the matched related characteristic. As can be seen, the additional information provided may be more in depth than the matched related characteristic displayed on the stamp. The dynamic data page 212 may include any type of data, including texts, video, audio, downloads, etc.

FIGS. 7-9 are schematic illustrations of messages 340 transmitted by a communication apparatus 310, in accordance with a third exemplary embodiment of the present disclosure. The communication apparatus 310 which may be referred to simply as ‘apparatus 310’ may include any of the structures, features, or functions disclosed with respect to any embodiment of this disclosure. Each of FIGS. 7-9 illustrate a message 340 with a data string 350 contained therein. Within the data string 350 is at least one recognizable keyword 360. For example, in FIGS. 7-8, the recognizable keyword 360 could be any one term or any combination of the terms “Sam Shields”, “Packers”, “San Francisco”, and/or “#GBvsSF”, among others, and in FIG. 9, the recognizable keyword 360 could be one or both of the terms, “McDonalds” and/or “sweet tea”. In the manner disclosed with respect to FIGS. 2-6, the recognizable keywords 360 of the data strings 350 may be processed to match them with a related characteristic 370, which may be displayed on the message 340 within a stamp 380.

Similar to the stamp discussed relative to FIG. 5, the stamps 380 of FIGS. 7-9 may include a graphical marking that easily distinguishes the stamp 380 and the matched related characteristic 370 from the data string 350. In addition to the stamp 380 including the matched related characteristic 370, it may also include a link 390 to additional information or additional functionality within the apparatus 310. This link 390 may be displayed as an icon, a word, or any other marking. For example, in FIG. 7, the link 390 is an icon of a microphone, which when selected, has the ability to stream or otherwise provide an audio clip that is relevant to the matched related characteristic 370. In FIG. 8, the link 390 is an icon of a camera, which when selected, has the ability to provide an image that is relevant to the matched related characteristic 370. In FIG. 9, the link 390 is an icon of a coupon, which when selected, has the ability to give details about a product or service and may allow the user to download a coupon for the product or service.

It is noted that while the examples set forth in this disclosure are primarily directed to sporting events, the apparatus 310 can be used in a variety of industries and with a variety of events. For example, the apparatus 310 may be used within the entertainment industry, the e-commerce industry, the news and media, TV, movies, fashion, medical, gossip, or any other area of industry or topic. Accordingly, additional features of the apparatus 310 may include the ability for a user to select related topics of interest and limit the stamps 380 and matched related characteristics 370 to their selected topics. For example, sports enthusiast may select to receive the stamp 380 and matched related characteristics 370 for sports, whereas one interested in music may only choose to receive music related stamps 380. Similarly, a user may choose to not receive stamps 380, such as stopping all stamps 380 concerning an upcoming game, because they do not want to have the outcome of the game spoiled by the stamp 380. This feature may stop stamps 380 with unwanted data from being displayed on a user device. The apparatus 310 may also offer subscriptions where the user can control what type of messages 340 will receive stamps 380. For example, a user may select to have stamps 380 created for only messages 340 relating to sports, and not for news, movies, etc.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A communication apparatus comprising:
a server;
first user device in communication with the server, wherein a message is communicated to the server, the message including at least one data string having at least one recognizable keyword;
a keyword module stored at least partially on the server, wherein the keyword module matches the at least one recognizable keyword with a related characteristic of the at least one recognizable keyword;
a stamping module in communication with the keyword module, wherein the stamping module embeds a stamp within the message, the stamp having at least a portion of the matched related characteristic of the data string; and
a second user device in communication with the server, wherein the second user device visually displays the message having the at least one data string and the matched related characteristic within the stamp on a display interface of the second user device.
